(19) United States
(12) Patent Application Publication
(10) Pub. No.: US 2026/0326593 A1
(43) Pub. Date: Oct. 22, 2026

(54) ROTOR FIELD EXCITATION OF SEPARATELY EXCITED MACHINE USING REDUNDANT CONVERTER STAGES

(71) Applicant: GM GLOBAL TECHNOLOGY OPERATIONS LLC, Detroit, MI (US)

(72) Inventors: Varoun Perumal, Novi, MI (US); Khorshed Mohammed Alam, Canton, MI (US); Ajay Mehta, Clarkston, MI (US); Muhammad A. Zahid, Troy, MI (US); Mazharul Chowdhury, Canton, MI (US); Minh-Khai Nguyen, Troy, MI (US); Lei Hao, Troy, MI (US)

(73) Assignee: GM GLOBAL TECHNOLOGY OPERATIONS LLC, Detroit, MI (US)

(21) Appl. No.: 19/184,025

(22) Filed: Apr. 21, 2025

(51) Int. Cl. B60L 53/24; B60L 1/00; B60L 15/04; B60L 50/52; B60L 50/60; B60L 53/10; B60L 55/00; H02M 1/42; H02M 1/44; H02M 3/335; H02M 7/219; H02M 7/5387

(52) U.S. Cl. CPC B60L 53/24; B60L 1/006; B60L 15/04; B60L 50/52; B60L 50/60; B60L 53/11; B60L 55/00; H02M 1/4233; H02M 1/44; H02M 3/33573; H02M 3/33592; H02M 7/219; H02M 7/5387; B60L 2220/20; B60L 2220/54

(57) ABSTRACT

A battery electric system includes a battery pack and a separately excited machine having first and second sets of rotor windings. A motor-inverter onboard charging module (OBCM) is connected to the battery pack and a charging inlet. Switches of first and second DC power stages of the OBCM are arranged in primary and vehicle-to-anything (V2X) H-bridges. The V2X H-bridge connects to the first set of rotor windings via a first mode switch. The primary H-bridge connects to the second set of rotor windings via a second mode switch. The second DC power stage is connected to the first stage via a transformer. The V2X H-bridge is connectable to a power outlet or the first set of rotor windings via the first mode switch. The ECU controls the mode switches to energize the rotor windings via the first and second DC power stages.

### INTRODUCTION

A separately excited machine (SEM) is a type of direct current (DC) motor characterized by its independent field and armature drive circuits. In a typical construction, stator-mounted field windings are energized to create a main magnetic field. Separate drive circuits are used to apply a voltage to rotor-mounted windings. Interaction of the armature current and field flux in the energized rotor windings produces torque on a rotary output member of the SEM. Variation of the armature voltage changes rotary speed at a constant torque level. Thus, the rotational speed of the SEM's output member is controllable by varying the armature voltage or by employing field weakening techniques. Due to the unique construction and control properties of an SEM relative to, e.g., an interior permanent magnet (IPM) motor, SEMs are useful in a myriad of electrical applications, including but not limited to industrial drive systems, electric vehicles, elevators, machine tools, and the like.

An electrified powertrain system of a mobile or stationary system may include one or more electric traction motors. In an electric vehicle (EV) application in particular, each traction motor is connected to one or more road wheels and energized by discharge of a high-voltage battery pack. When energized, a traction motor generates output torque to rotate the road wheels and thereby propel the EV. While modern EVs are typically equipped with IPM motors, certain performance advantages of an SEM construction may lead to a more widespread adoption of SEM-based propulsion systems in EVs and other mobile applications.

### SUMMARY

Disclosed herein are systems and methods for exciting a rotor field of a dual-wound separately excited machine (SEM) in a battery electric circuit having the SEM and a motor-inverter configured to function as an onboard charging module (OBCM), i.e., as a “motor-inverter OBCM”. The motor-inverter OBCM has “vehicle-to-anything” functionality. The motor-inverter OBCM also includes multiple direct current power conversion stages (“DC power stages”). A first DC power stage of the motor-inverter OBCM is configured herein as a “vehicle-to-load” (V2L) or a “vehicle-to-anything” (V2X) circuit, with the latter “V2X” designation used hereinafter for illustrative consistency. The V2X portion of the OBCM circuit includes an H-bridge, which is referred to herein as a V2X H-bridge for clarity. A second DC power stage of the motor-inverter OBCM, used as a primary excitation power stage, includes a corresponding H-bridge referred to herein as a “primary” H-bridge for clarity, i.e., to distinguish the H-bridge of a DC-DC stage of the motor-inverter OBCM (the second power stage) from the V2X H-bridge in the various topologies described below.

The SEM rotor of the present disclosure is “dual-wound” in the sense that the rotor has two (or more) sets of rotor windings. The different sets of rotor windings are separately energized by the first and second DC power stages of the motor-inverter OBCM, with the DC power stages formed by the respective V2X and primary H-bridges. Redundancy of the DC power stages enables their selective use to energize the rotor windings using the same or different utilization rates, thereby reducing the likelihood of occurrence of a fault-related loss of propulsion. Additionally, the present teachings allow for various numbers of rotor winding turns, current sharing to help limit overheating of/losses in the rotor winding, and opportunities to improve upon existing SEM performance.

In a particular embodiment, a battery electric system includes a battery pack, a dual-wound SEM, a motor-inverter-based OBCM (“motor-inverter OBCM”), a transformer, first and second DC power stages, and an electronic control unit (ECU). The SEM includes a rotary output member, a stator having stator windings connectable to a charging inlet, and a rotor having separate first and second sets of rotor windings. The motor-inverter OBCM is connected to the battery pack and to a charging inlet. The charging inlet in turn is selectively connectable to the stator windings to energize the motor-inverter OBCM and charge the battery pack.

The second DC power stage (PS2) in this embodiment, i.e., the DC-DC stage of the above-noted motor-inverter OBCM, has a plurality of semiconductor switches arranged in a primary H-bridge. The primary H-bridge is selectively connectable to the second set of rotor windings via a second mode switch (SM2). The first DC power stage (PS1) is connected to the first DC-DC stage and has a plurality of semiconductor switches arranged in a V2X H-bridge. The V2X H-bridge is selectively connectable to a power outlet or the first set of rotor winding via a first mode switch (SM1). The ECU is configured to control an ON/OFF switching state of the first and second mode switches (SM1, SM2) to independently energize the rotor windings via the respective first and second DC power stages.

The ECU may independently energize the first set of rotor windings via the first DC power stage in response to a detected fault of the second DC power stage, and vice versa.

The SEM may be constructed as a contact-type SEM or a noncontact-type SEM. In the latter embodiment, the noncontact-type SEM may include a multi-winding rotary transformer having a stationary primary side and a rotating secondary side, with a pair of rectifier circuits each connected to the rotating secondary side.

The first set of rotor windings and the second set of rotor windings have an equal number of turns or a different number of turns.

The battery electric system may include a sensor operable for sensing a temperature of the rotor. The ECU in such an embodiment may switch between the first and second DC power stages based at least in part on the temperature of the rotor, thereby minimizing losses in the rotor.

The primary H-bridge of the second DC power stage is operable in some topologies for outputting a split-phase, 120V/240V output to the power outlet.

The motor-inverter OBCM may include a power factor correction (PFC) stage operable for receiving a single-phase AC voltage from the charging inlet. The motor-inverter OBCM is also optionally operable for receiving a direct current fast-charging (DCFC) voltage from the charging inlet.

The ECU described herein may be configured to determine a rotor load condition of the rotor, and to independently adjust a corresponding utilization rate of the first DC power stage and the second DC power stage based on the rotor load condition. The ECU may be programmed with load designations or cutoffs for the rotor load conditions, including a nominal load, a peak load, and a light load. The ECU may also independently adjust the corresponding utilization rate to (a) 50% for each of the first DC power stage and the second DC power stage during the nominal load, thus balancing losses between the first DC power stage and the second power stage, (b) 100% for each of the first DC power stage and the second DC power stage during the peak load, and (c) less than 40% for the first DC power stage or the second DC power stage, during the light load, while placing the other of the first DC power stage or the second DC power stage placed in a standby mode.

The ECU may also manage losses of the rotor by scheduling operation of the first DC power stage and the second DC power stage when exciting the rotor.

A vehicle is also disclosed herein that includes a vehicle body. A set of road wheels, a charging inlet, and a power outlet are connected to the vehicle body. The vehicle includes a battery electric system having a battery pack, a dual-wound SEM having an output member connected to one or more of the road wheels, a stator having stator windings connectable to a charging inlet, and a rotor having a first set of rotor windings and a second set of rotor windings. Additionally, the battery electric system of the vehicle includes a transformer and a motor-inverter OBCM, the latter being connected to the battery pack and to the charging inlet. The charging inlet is selectively connectable to the stator windings to energize the motor-inverter OBCM and charge the battery pack.

The motor-inverter OBCM in this embodiment includes a first DC power stage (PS1) having a plurality of semiconductor switches arranged in a vehicle-to-anything (V2X) H-bridge of the motor-inverter OBCM, with the V2X H-bridge being selectively connectable to the power outlet or the first set of rotor windings via a first mode switch (SM1). A second DC power stage (PS2) is connected to the first DC power stage (PS1) via the transformer, and has a plurality of semiconductor switches arranged in a primary H-bridge of the motor-inverter OBCM. The primary H-bridge is selectively connectable to the power outlet or the second set of rotor winding via a second mode switch (SM2). An ECU is configured to control an ON/OFF switching state of the first mode switch (SM1) and the second mode switch (SM2) to independently energize the first set of rotor windings and the second set of rotor windings via the second and first DC power stages, respectively.

Also disclosed herein is a method for controlling a dual-wound SEM in a battery electric circuit of a vehicle. An embodiment of the method includes determining, via an ECU of the vehicle, a mode of operation of the battery electric circuit as one of an initialization mode, a charging mode of a battery pack of the battery electric circuit, and a propulsion mode of the vehicle. The method also includes controlling an ON/OFF switching state of a first mode switch (SM1) and a second mode switch (SM2) of a motor-inverter OBCM of the battery electric circuit, via the ECU, to independently energize a first set of rotor windings of the SEM and a second set of rotor windings of the SEM. This occurs via respective first and second DC power stages of the motor-inverter OBCM, the first and second DC power stages each having a corresponding plurality of semiconductor switches arranged in a respective H-bridge, including independently energizing the first set of rotor windings via the first DC power stage in response to a detected fault of the second DC power stage, and vice versa.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 is an illustration of a representative battery electric system having a dual-wound separately excited machine (SEM) controllable via multiple direct current (DC) power stages of a motor-inverter-based onboard charging module (OBCM) as set forth herein.

FIG. 2 illustrates a representative circuit topology for the battery electric system of FIG. 1.

FIG. 3 illustrates a portion of a dual-wound rotor for the SEM shown in FIGS. 1 and 2, with redundant rotor field windings of the SEM being energized via separate DC power stages in accordance with the disclosure.

FIG. 3A illustrates a non-contact/inductive embodiment of the SEM rotor shown in FIG. 3.

FIG. 4 is a flow chart illustrating a representative method for controlling the SEM of FIGS. 1 and 2.

FIGS. 5A and 5B are illustrations of different states of first and second mode switches of the battery electric system shown in FIG. 2.

FIG. 6 is a flow chart illustrating a method for controlling the SEM of FIGS. 1 and 2 in accordance with another embodiment.

FIGS. 7A and 7B illustrate alternative embodiments of a SEM rotor usable as part of the battery electric system of FIG. 2.

The present disclosure may be modified or embodied in alternative forms, with representative embodiments shown in the drawings and described in detail below. Inventive aspects of the present disclosure are not limited to the disclosed embodiments. Rather, the present disclosure is intended to cover alternatives falling within the scope of the disclosure as defined by the appended claims.

### DETAILED DESCRIPTION

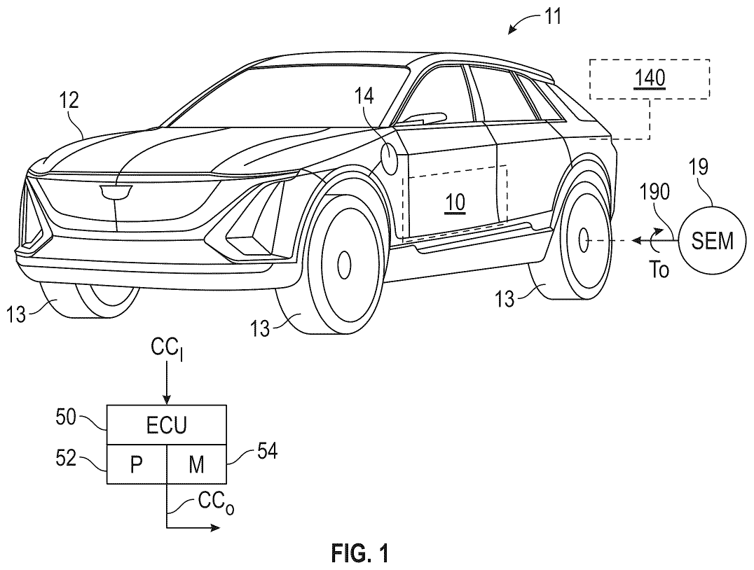

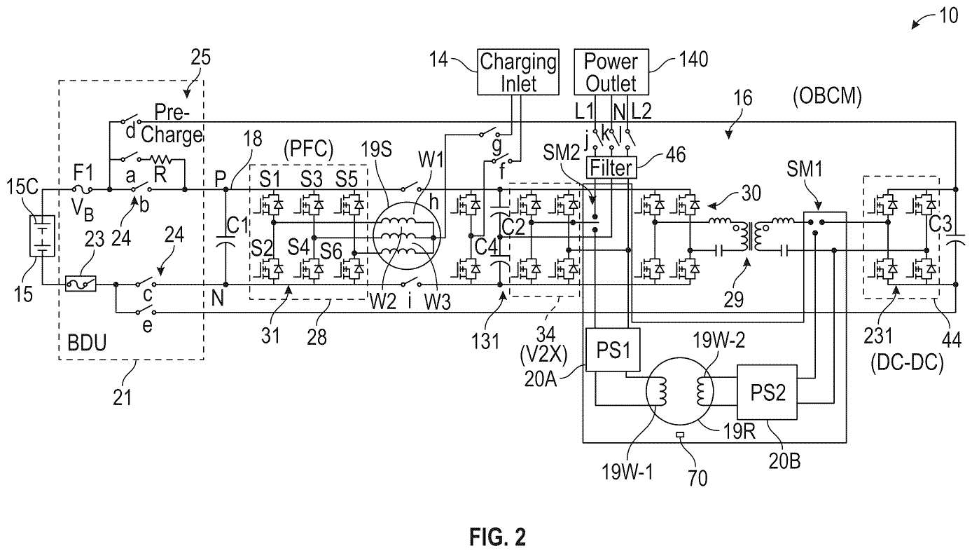

Referring to the drawings, wherein like reference numbers refer to like features throughout the several views, FIG. 1 depicts a battery electric system 10 constructed and controlled as set forth herein with reference to FIGS. 2-7B. In the representative embodiment of FIG. 1, the battery electric system 10 is used aboard a mobile system 11, e.g., an electric vehicle, a hybrid electric vehicle, a robot, a mobile platform, etc. In a vehicular construction, the mobile system 11 includes a vehicle body 12, road wheels 13, and a charging inlet 14, with the road wheels 13 and the charging inlet 14 connected to the vehicle body 12. In other implementations, the battery electric system 10 may be used as part of an industrial drive system, an elevator, a machine tool, a hoist, and the like. Therefore, the representative vehicular application of FIG. 1 is just one possible use of the battery electric system 10. A power outlet 140 is also connected to the vehicle body 12 at an accessible location to output electrical power to an external load as part of a vehicle-to-load (V2L) or a vehicle-to-anything (V2X) application.

The battery electric system 10 of FIG. 1 includes a dual-wound separately excited machine (SEM) 19 having a rotary output member 190 connected to one or more of the road wheels 13. When the SEM 19 is energized, output torque (To) generated by the SEM 19 is transmitted to the road wheel(s) 13 to propel the mobile system/vehicle 11. Although omitted for illustrative simplicity, the battery electric system 10 may also include an auxiliary power module (APM) and an auxiliary battery in some embodiments. As appreciated in the art, an APM in the form of a DC-DC buck converter is typically operable for reducing the voltage level of a DC voltage bus, e.g., a DC voltage bus 18 shown in FIG. 2 and described below, to lower/auxiliary levels, e.g., 12-15V, suitable for charging the auxiliary battery and/or powering lights, display screens, and other auxiliary systems aboard the mobile system 11.

Instructions for controlling the battery electric system 10, and in particular the SEM 19, may be embodied computer-readable instructions and executed by a processor (P) 52 from memory (M) 54 of an electronic control unit (ECU) 50. The ECU 50 may receive input signals (CC_{I}) from various sensors or control processors (not shown) of the mobile system 11, e.g., operating mode requests, torque requests, charging requests, measured currents, voltages, temperatures, and the like. In response, the ECU 50 may transmit output signals (CC_{O}) to control an output state of the battery electric system 10, and in particular various constituent switches thereof as described below with reference to FIG. 2.

The processor 52 may include various combinations of Application Specific Integrated Circuit(s) (ASIC), Field-Programmable Gate Arrays (FPGAs), electronic circuit(s), central processing unit(s), e.g., microprocessor(s). The memory 54 may include magnetic or optical media, CD-ROM, and/or solid-state/semiconductor memory, e.g., several types of RAM or ROM, and associated non-transitory memory component(s) in the form of memory and storage devices (read only, programmable read only, random access, hard drive, etc.). Non-transitory components of the memory 54 used herein are capable of storing machine-readable instructions in the form of one or more software or firmware programs or routines, combinational logic circuit(s), input/output circuit(s) and devices, signal conditioning and buffer circuitry and other components that can be accessed by one or more processors 52 to provide a described functionality.

Referring now to FIG. 2, the battery electric system 10 may include a high-voltage electrochemical battery 15, for instance a traction battery pack having an application-specific number of battery cells 15C such as lithium-ion, nickel-metal-hydride, solid-state, etc. The battery pack 15 is connected to a motor-inverter-based onboard charging module (“motor-inverter OBCM”) 16 via the above-noted DC voltage bus 18. A voltage of about 400V to 800V in a possible implementation is present on the DC voltage bus 18. The DC voltage bus 18 is connected to the SEM 19 of FIG. 1, which is configured and controlled as set forth below with reference to FIGS. 2-7B.

The battery pack 15 is in series with a main fuse (F1) within a battery disconnect unit (BDU) 21. The battery pack 15, which may be rapidly disconnected from the positive (P) and negative (N) rails of the DC voltage bus 18 during a fault via operation of a pyrotechnic switch 23 as shown, is connectable to the DC voltage bus 18 via main contactors 24, labeled switches (b) and (c) in FIG. 2 for added clarity. The battery pack 15 may be charged as needed via operation of a pre-charge circuit 25 having a current-limiting resistor (R) in series with a pre-charge contactor switch (a) and in parallel with one of the main contactors 24, in this case switch (b) on the positive rail of the DC voltage bus 18.

As appreciated in the art, the closing of the pre-charge contactor, i.e., switch (b), causes a battery current to flow from the battery pack 15 and through the current-limiting resistor (R) within the pre-charge circuit 25. This action in turn gradually charges a DC link capacitor (C1) until a DC link voltage stored therein is approximately equal to the battery voltage (V_{B}). The main contactors 24 are thereafter commanded by the ECU 50 of FIG. 1 to close, e.g., via the output signals (CC_{O}) of FIG. 1, and the pre-charge contactor, switch (a), is commanded to open. The battery electric system 10 is thereafter ready for operation, for instance when powering the SEM 19 of FIG. 1 during a propulsion mode of the mobile system 11. Optional bypass switches (d) and (e) may be selectively closed to bypass the circuitry of FIG. 2 in one or more implementations.

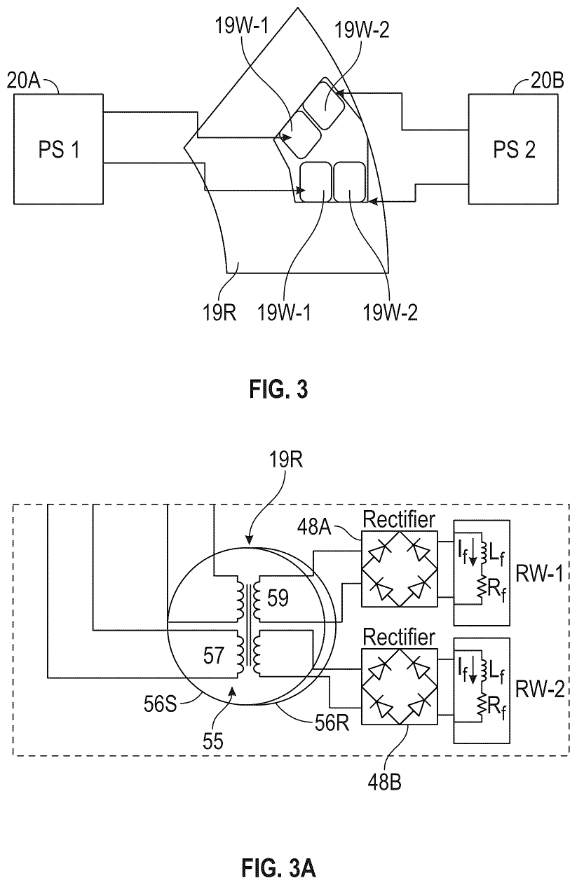

The SEM 19 of FIG. 1 is illustrated in FIG. 2 with its stator 19S shown apart from its rotor 19R for illustrative clarity. Depending on the application, the SEM 19 may be constructed as a contact-type SEM (FIG. 2) or a noncontact-type SEM (FIG. 3A) within the scope of the disclosure. As appreciated by those of ordinary skill in the art, a “contact-type” SEM employs physical slip rings and brushes, typically constructed of copper and carbon, respectively, to maintain correct current direction in the windings of the stator 19S. In contrast, and as the name implies, a “noncontact-type” SEM construction uses electronic/inductive-based commutation through in lieu of mechanical commutation, thus eliminating the above-described sliding contacts, reducing wear and tear and friction losses. Both SEM constructions may be used as part of the battery electric system 10 of the present disclosure.

The individual phase windings W1, W2, and W3 of the stator 19S are connectable to the charging inlet 14 (also see FIG. 1) during a charging mode of the battery pack 15. In different implementations, the motor-inverter OBCM 16 is operable for receiving a single-phase alternating current (AC) charging voltage from the charging inlet 14, e.g., about 85V-270V, or the charging inlet may receive a DC fast charging (DCFC) voltage of, for instance, about 300-900V. As noted above, the dual-wound rotor 19R of the SEM 19 includes redundant windings, represented herein as first and second sets of rotor windings 19W-1 and 19W-2. Respective first and second mode switches (SM1, SM2) are controlled by the ECU 50 of FIG. 1 to energize the rotor 19R using existing DC stage structure of the battery electric system 10. A sensor 70 may be connected to or placed in proximity to the rotor 19R, with the sensor 70, e.g., a thermistor, a thermocouple, or a remote sensor operable for sensing a temperature of the rotor 19R. The ECU 50 may be configured to switch between a first DC power stage 20A (PS1) and a second DC power stage 20B (PS2) based at least in part on the measured temperature of the rotor 19R to thereby minimize losses in the rotor 19R.

Referring briefly to FIG. 3, the rotor 19R is wound with the first and second sets of rotor windings 19W-1 and 19W-2 as shown, i.e., redundant windings. The ECU 50 (FIG. 1) is configured to control an ON/OFF switching state of the first mode switch (SM1) and the second mode switch (SM2) of FIG. 2 to independently energize the first set of rotor windings 19W-1 and the second set of rotor windings 19W-2, respectively. This occurs via the separate first and second DC power stages 20A, 20B (PS1, PS2) of the motor-inverter OBCM 16. In different embodiments, the first set of rotor windings (19W-1) and the second set of rotor windings (19W-2) have an equal number of turns, i.e., N1=N2, or a different number of turns (N1≠N2). While two DC power stages are shown in FIG. 2, additional DC power stages may be implemented in other embodiments.

Referring once again to FIG. 2, the respective first and second DC power stages (PS1, PS2) of FIG. 3 are used to independently energize the redundant first and second sets of rotor windings 19W-1 and 19W-2. Specifically, the first and second DC power stages (PS1, PS2) act as the DC-DC isolation stage of the motor-inverter OBCM 16. Emerging electrical systems such as the mobile system/vehicle 11 of FIG. 1 may be equipped with V2X capabilities that allow the battery pack 15 to serve as an available DC power supply when connecting to and powering external electrical devices and appliances. For instance, users of the mobile system 11 may wish to connect loads such as refrigerators, coffee makers, computers, fans, radios, lights, power tools, or other loads that may be required when disconnected from grid power, e.g., while camping in a remote location. The representative V2X architecture described below therefore provides available circuitry for exciting the rotor 19R.

As part of the illustrated topology of FIG. 2, the motor-inverter OBCM 16 is connected to the battery pack 15, the charging inlet 14, and the power outlet 140. The motor-inverter OBCM 16 includes a power factor correction (PFC) stage 28 operable for converting an AC input voltage into a DC output voltage. The motor-inverter OBCM 16 also includes a multi-stage DC-DC converter 30 having a transformer 29 providing galvanic isolation and voltage conversion. The motor-inverter OBCM 16 charges the battery pack 15 from a standard AC power source, in this case via the charging inlet 14.

The PFC stage 28 of FIG. 2 includes a plurality of semiconductor switches 31, shown as representative voltage-controlled metal oxide semiconductor field-effect transistors (MOSFETs), e.g., N-type MOSFETs as shown, or insulated-gate bipolar transistors (IGBTs), etc. For a representative polyphase embodiment of the stator 19S, each of the phases is connected to a separate switching leg, i.e., switching pairs (S1, S2), (S3, S4), and (S5, S6) forming high/low switching pairs of switches S1, S2, S3, S4, S5, and S6, as appreciated in the art. Additional positive and negative contactors, switches (h, i), may be arranged on the respective positive and negative rails of the DC voltage bus 18 as shown to selectively connect or disconnect the OBCM 16.

The charging inlet 14 of FIG. 2 is selectively connectable to the stator windings (W1, W2, W3) of the stator 19S, e.g., via charging switches (f, g). When battery charging is required, for instance when a measured or calculated state of charge of the battery pack 15 drops below a state of charge (SOC) threshold, e.g., 20-30%, electrical power is supplied to the stator windings (W1, W2, W3) via the charging inlet 14 over closed switches (f, g) to energize the motor-inverter OBCM 16 and charge the battery pack 15.

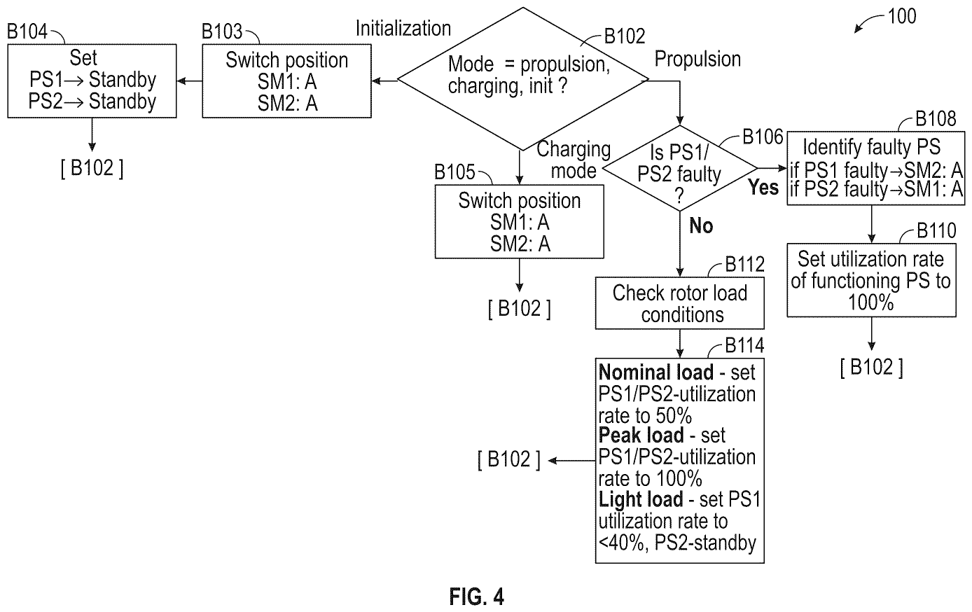

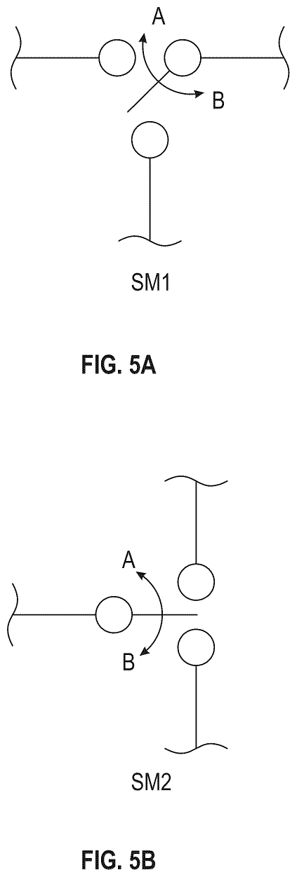

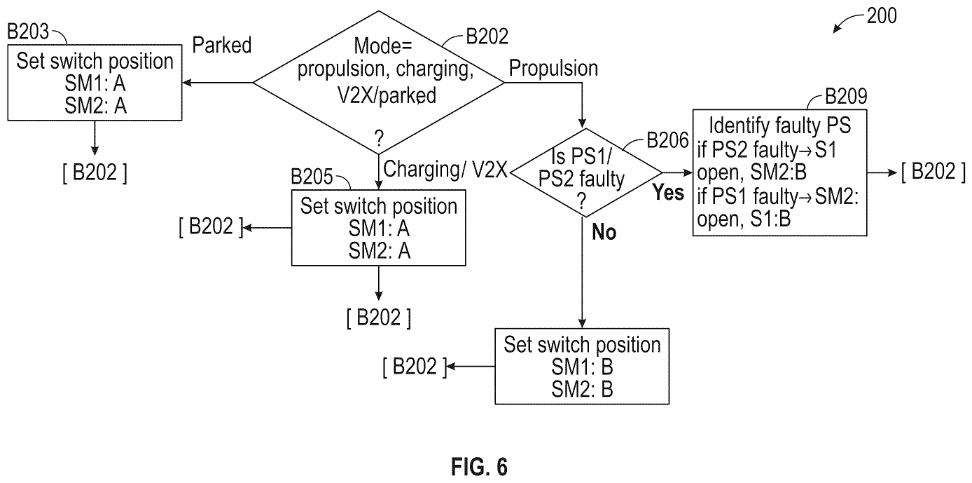

Still referring to FIG. 2, the battery electric system 10 includes the first and second mode switches (SM1, SM2), e.g., solid-state relays or contactors, each having position states A and B as shown in FIGS. 5A and 5B. The position states are described below with reference to the methods 100 and 200 of FIGS. 4 and 6, respectively. The battery electric system 10 also includes the first DC power stage (PS1), which has an additional plurality of semiconductor switches 131, shown as representative MOSFETs for illustrative consistency. The semiconductor switches 131 of the first DC power stage (PS1) are arranged in a first H-bridge, with the first H-bridge 34 also referred herein as a V2X H-bridge 34 for clarity. The first/V2X H-bridge 34 in turn is selectively connectable to the first set of rotor windings (19W-1) via the first mode switch (SM1). The transformer 29 is positioned between the first DC power stage (PS1) and the second DC power stage (PS2), with the transformer 29 forming an integral component of the DC-DC converter stage 30 of the motor-inverter OBCM 16.

The second DC power stage (PS2) of FIG. 2 is connected to the first DC-DC stage (PS1) via the transformer 29 and the first mode switch (SM1). The second DC power stage (PS2) includes a plurality of semiconductor switches 231, four of which are arranged in a second/primary H-bridge 44. As before, the semiconductor switches 231 of the second DC power stage (PS2) are shown as representative MOSFETs for illustrative consistency. Additional semiconductor switches and capacitors (C2, C4) may be connected to the DC voltage bus 18 between the PFC stage 28 and the primary H-bridge 44 of the second DC power stage (PS2).

The primary H-bridge 44 is connected to another capacitor (C3) in this exemplary circuit topology and selectively connectable to the power outlet 140 for connecting to an external load in the above-described V2X application, or to the second set of rotor windings (19W-2) as needed for propulsion. This action occurs via operation of the first mode switch (SM1). The semiconductor switches 231 of the primary H-bridge 44 may be connected to the power outlet 140 via a power filter block 46, with switches (j, k, l) connecting to Line 1 (L1), Neutral (N), and Line 2 (L2) traces for split-phase power, e.g., 120V/240V in a representative V2X application. As appreciated in the art, the first and second lines L1 and L2 in a typical North American application carries 120 VAC. Thus, the closing of switch (k) and either of the switches (j) or (l) would result in delivery of 120 VAC to a load when connected to the power outlet 140. When 240 VAC is required by the connected load, for instance when powering an air conditioning unit or heat pump, the switches (j) and (l) may be closed and switch (k) opened. The primary H-bridge 44 is thus operable for outputting a split-phase, 120V/240V output to the power outlet 140 in one or more implementations.

The rotor 19R of the SEM 19 of FIG. 1 is thus separately powered by either or both of the first and second DC power stages (PS1, PS2). In the illustrated embodiment of FIG. 2, the V2X H-bridge 34 of the first DC power stage (PS1) is used to energize the first set of rotor windings (19W-1). The ECU 50 of FIG. 1 is configured to control an ON/OFF switching state of the first mode switch (SM1) and the second mode switch (SM2) to independently energize the first rotor windings (19W-1) and the second rotor windings (19W-2) via the corresponding H-bridges of the first and second DC power stages (PS1 and PS2), respectively.

FIG. 3A illustrates an alternative “non-contact-type” implementation of the rotor 19R in which inductive-based dual excitation is used to energize the redundant rotor windings (RW-1, RW-2), with field current (I_{f}), inductors (L_{f}), and resistors (R_{f}) shown in the simplified circuit depiction. Here, separate rectifier circuits 48A and 48B may be connected to the respective first and second rotor windings (RW-1, RW-2) as shown. A multi-winding rotary transformer 55 is connected to the first and second mode switches (SM1 and SM2) of FIG. 2. As appreciated, such a rotary transformer 55 is configured to transfer energy between a stationary primary side 56S and a rotating secondary side 56R, without physical contact therebetween, i.e., without the above-noted brushes and slip rings or comparable structure.

In a possible implementation, the stationary primary side 56S has multiple windings 57 is in non-contact proximity to windings 59 of the rotating secondary side 56R, with electromagnetic induction used to generate magnetic flux across an airgap between the primary and secondary sides 56S, 56R. Outputs of the rectifier circuits 48A, 48B feed into the first and second rotor windings (RW-1, RW-2). In both the contact-type implementation (FIG. 2) and the non-contact-type implementation (FIG. 3A), the redundant rotor windings of the rotor 19R are powered by the separate DC power stages using the available H-bridge circuitry of the battery electric system 10.

REDUNDANCY AND CONTROL: The redundant configuration of the above-described rotor 19R, which is energized by separate DC power stages, ensures fault tolerance of the battery electric system 10. For example, the ECU 50 of FIG. 1 may be configured to independently energize the first set of rotor windings (RW-1) via the first DC power stage (PS1) in response to a detected fault of the second DC power stage (PS2), and vice versa. Approaches for controlling the SEM 19 of FIG. 1 will now be described with reference to the remaining Figures.

Referring to FIG. 4, the method 100 may be performed by the ECU 50 of FIG. 1 by executing computer-readable instructions from its memory 54. Performance of the method 100 allows for the SEM dual-wound rotor windings (RW-1, RW-2) to be excited via existing H-bridges not otherwise used during traction applications. For clarity, the method 100 is described in terms of algorithm code segments or logic blocks, with each logic block representing corresponding code for performing a described step.

In general, the method 100 is suitable for controlling the dual-wound SEM 19 in the battery electric system 10 of the mobile system/vehicle 11 shown in FIG. 1. The method 100 includes determining, via the ECU 50 of the mobile system 11, a mode of operation of the battery electric system 10 as one of an initialization mode, a charging mode of the battery pack 15 of the battery electric system 10, and a propulsion mode of the mobile system 11. The method 100 also includes controlling an ON/OFF switching state of the first mode switch (SM1) and the second mode switch (SM2) of the motor-inverter onboard charging module (OBCM) 16 of the battery electric system 10. This action occurs via the ECU 50 to independently energize the first set of rotor windings (RW-1) of the SEM 19 and the second set of rotor windings (19W-2) of the SEM 19 via the respective second and first DC power stages (PS2, PS1) of the motor-inverter OBCM 16. As noted above, the first and second DC power stages (PS1, PS2) each have a corresponding plurality of semiconductor switches 131, 231 arranged in a corresponding H-bridge. The method 100 includes independently energizing the first set of rotor windings (RW-1) via the first DC power stage (PS1) in response to a detected fault of the second DC power stage (PS2), and vice versa.

The method 100 may further include determining a rotor load condition of the rotor 19R via the ECU 50, and then independently adjusting a corresponding utilization rate of the first power stage (PS1) and the second power stage (PS2) via the ECU 50 based on the rotor load condition. The ECU 50 may be programmed with the designations for the rotor load conditions, including a nominal load, a peak load, and a light load as noted herein. These and other functions may be used in the embodiment of the method 100 shown in FIG. 4.

Commencing with block B102 of FIG. 4, the ECU 50 of FIG. 1 may check the mode of operation of the mobile system 11 to determine if the current operating mode is (i) propulsion (P), (ii) charging (C) of the battery pack 15, or (iii) initialization (I). The ECU 50 may perform block B102 by processing the input signals (CC_{I}) of FIG. 1, for instance transmission settings, speed of the SEM, torque request, measured currents/voltages/temperatures, etc., some of which may be sensed and reported by the sensor 70 of FIG. 2. The method 100 proceeds to block B103 when the mode of operation is the initialization mode, to block B105 when the mode of operation is the charging mode, and to block B106 when the mode of operation is the propulsion mode.

Block B103 includes transitioning the respective first and second mode switches SM1 and SM2 of FIG. 2 to position (A), as best shown in FIG. 5A (for the first mode switch SM1) and FIG. 5B (for the second mode switch SM2). In FIGS. 5A and 5B, position B corresponds to connection to the rotor 19R, with position A delivering power to the power outlet 140 or receiving power from the charging inlet 14 depending on the commanded operation. The method 100 proceeds to block B104 after transitioning the first and second mode switches SM1 and SM2 in this manner.

Block B104 entails setting the first and second DC power stages (PS1, PS2) to a standby mode. In such a mode, the first and second DC power stages (PS1, PS2) do not generate power, and thus do not excite the rotor 19R of the SEM 19.

At block B105, i.e., charging mode, the ECU 50 likewise transitions the respective first and second mode switches SM1 and SM2 of FIG. 2 to position (A), as shown in FIGS. 5A and 5B. Block B105 is thus analogous to block B103. The battery pack 15 is thereafter charged via the motor-inverter OBCM 16 using the charging inlet 14.

At block B106, during a propulsion mode the ECU 50 determines whether either of the power stages (PS1, PS2) is faulty. In a typical implementation, the ECU 50 receives current sensor-based or other fault data, e.g., over a CAN bus, and is thus continuously or periodically informed of electrical faults in the first and second DC power stages (PS1, PS2). The method 100 proceeds to block B108 when a fault is detected in one of the power stages (PS1, PS2), and to block B112 in the alternative when an electrical fault is not detected.

Block B108 of the method 100 shown in FIG. 4 includes identifying the faulty DC power stage from block B106 as being the first or second DC power stage (PS1 or PS2), and then executing a switching control action based on the identity of the faulty power stage. The ECU 50 may respond to a fault in the first DC power stage (PS1) by transitioning the second mode switch (SM2) to position A of FIG. 5B. The ECU 50 may perform the opposite action when the fault is present in the second DC power stage (PS2), i.e., by transitioning the first mode switch (SM1) to position A (FIG. 5A). The method 100 thereafter proceeds to block B110.

Block B110 includes setting the utilization rate of the properly functioning DC power stage (PS1 or PS2) to 100%. That is, actual motor operation and excitation of the rotor 19R is performed solely by the functioning DC power stage, with the faulty stage not used to power the rotor 19R.

At block B112, the ECU 50 of FIG. 1 may be configured to determine a rotor load condition of the rotor 19R, and to independently adjust a corresponding utilization rate of the first DC power stage and the second DC power stage based on the rotor load condition. For example, the ECU 50 may at factors such as torque request, motor acceleration, etc., to determine the load on the rotor 19R. The method 100 thereafter proceeds to block B114.

Block B114 entails executing a control action based on the load from block B112. In a possible implementation, the ECU 50 may independently adjust a corresponding utilization rate of the first DC power stage (PS1) and the second DC power stage (PS2) as needed based on the rotor load condition. The ECU 50 may perform different control actions based on whether the rotor load is a nominal, peak, or light load, e.g., using arbitrary designations or cutoffs. For a nominal load, the ECU 50 may set the utilization rate of the first and second power stages to 50% each, thus balancing losses, or to another application-specific default allocation. Such an approach may help balance losses between the first and second DC power stages (PS1, PS2). For peak loads, the utilization rate may be set to 100%. For light loads, the ECU 50 may set the utilization rate of one of the DC power stages (PS1 or PS2) to a lower value, e.g., about 40% or less, with the other power stage placed in a standby mode.

The following table presents a table describing the various settings or states of the first and second DC power stages (PS1, PS2), the first and second mode switches (SM1, SM2), and the corresponding operating mode of the battery electric system 10 (FIG. 1), as determined during performance of the method 100 of FIG. 4.

| PS1 | PS2 | SM1 | SM2 | Mode |
|---|---|---|---|---|
| 50% | 50% | B | B | Normal |
| <40% | Standby | B | B | Normal - Light |
| 100% | 100% | B | B | Normal - Peak |
| 100% | Fault State | B | A | Redundant |
| Fault State | 100% | A | B | Redundant |
| Standby | Standby | B | B | Initialization |
| Non-propulsion | Non-propulsion | A | A | AC Charging |

Referring to FIG. 6, a method 200 allows for switching between charging of the battery pack 15, V2X operations, and rotor excitation modes. As noted above, the first and second mode switches (SM1, SM2) are added herein to the motor-inverter OBCM topology of FIG. 2 to allow for the rotor windings (19W-1, 19W-2) to be excited via existing H-bridges when not otherwise employed during traction applications.

Commencing with block B202, the ECU 50 of FIG. 1 may check the mode of operation of the mobile system 11 to determine if the current operating mode is (i) a propulsion mode, (ii) a charging mode of the battery pack 15, or (iii) V2X/parked. The ECU 50 may perform block B202 by processing the input signals (CC_{I}), for instance transmission settings, speed of the SEM 19, torque request, etc. The method 200 proceeds to block B203 when the mode of operation is the parked mode, to block B205 when the mode of operation is the charging mode/V2X, and to block B206 when the mode of operation is the propulsion mode.

At block B203, the ECU 50 transitions the first and second mode switches (SM1, SM2) of FIG. 2 to position (A), as shown in FIG. 5A (for the first mode switch SM1) and FIG. 5B (for the second mode switch SM2). The method 200 may resume with block B202.

At block B205, i.e., the charging mode/V2X mode, the ECU 50 transitions the respective first and second mode switches SM1 and SM2 of FIG. 2 to position (A) as shown in FIGS. 5A and 5B. Block B205 is thus analogous to block B105. The battery pack 15 is thereafter charged via the motor-inverter OBCM 16 of FIG. 2 and the charging inlet 14, or the V2X operation is conducted to offload power via the power outlet 140. The latter may entail delivering split phase power, e.g., 120-240 VAC, to an external load, or charging the battery pack 15 using AC power provided to the motor-inverter OBCM 16 via the charging inlet 14.

Block B206 is performed during a propulsion mode, with the ECU 50 determining whether either of the first or second DC power stages (PS1, PS2) is faulty. In a typical implementation, the ECU 50 receives current sensor-based or other fault data as noted above, e.g., over a CAN bus, and is thus continuously or periodically informed of electrical faults in the first and second DC power stages (PS1, PS2). The method 200 thereafter proceeds to block B207 when a fault is not detected, and to block B209 in the alternative when an electrical fault is detected in one of the DC power stages.

Block B207 includes setting the respective first and second mode switches SM1 and SM2 to position B of FIGS. 5A and 5B.

At block B209, the ECU 50 next identifies the faulty DC power stage from block B206 and takes appropriate action. The ECU 50 may respond to a fault in the second DC power stage (PS2) by commanding the first mode switch (SM1) to an open state, i.e., between positions A and B in FIG. 5A, and transitioning the second mode switch (SM2) to position (B). See FIG. 5B. Alternatively, the ECU 50 may respond to a fault in the first DC power stage (PS1) by commanding the second mode switch (SM2) to an open state and transitioning the first mode switch (SM1) to position (B), as shown in FIG. 5A.

The following table describes the states of the first and second mode switches SM1 and SM2, along with the corresponding operating mode of the battery electric system 10, with the various states described above with reference to the method 200 of FIG. 6:

| SM1 | SM2 | Mode |
|---|---|---|
| A | A | Parked |
| A | A | AC Charging |
| A | A | AC Charging + Split Phase |
| B | B | Traction |
| B | Open | Traction with RW-1 Fault |
| Open | B | Traction with RW-2 Fault |

where RW-1 and RW-2 represent the first and second rotor windings, respectively.

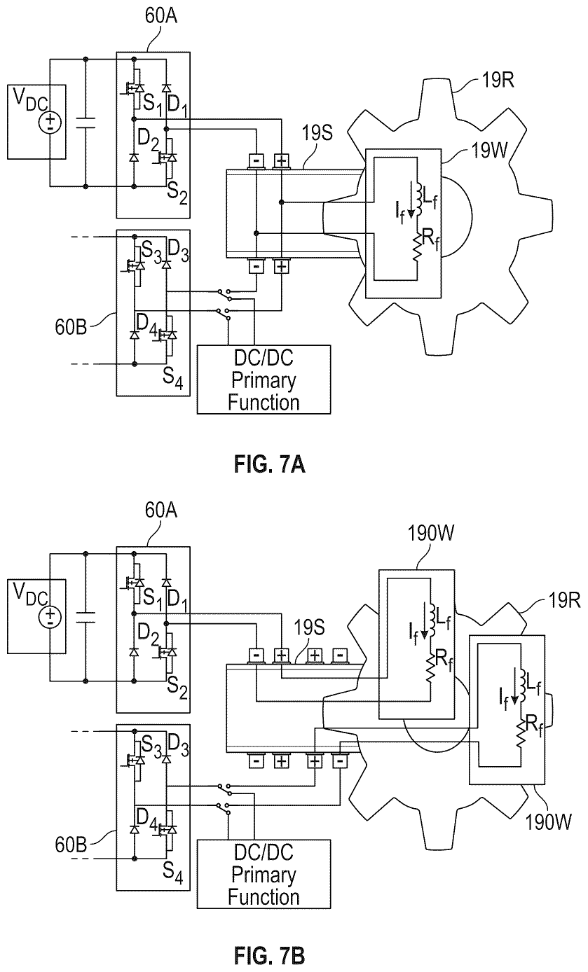

Referring to FIGS. 7A and 7B, the availability of multiple secondary power stages in the battery electric system 10 of FIG. 1 provides two or more sets of rotor windings (RW-1, RW-2) to be powered, depending on the operation of the mobile system/vehicle 11. The battery electric system 10 may enable a fault tolerant propulsion system. The battery electric system 10, specifically its motor-inverter OBCM 16, includes various DC-DC converter stages each with corresponding H-bridges, i.e., the primary H-bridge 44 and the V2X H-bridge 34 of FIG. 2. When the H-bridges 34 is not being utilized, the stage may be used to excite the rotor windings 19W-2 of the rotor 19R.

There are several ways such DC stages may be used. In FIG. 7A, for instance, a single rotor winding 19W is fed by multiple converters 60A, 60B. Such an approach may allow for a superposition effect on the single excited rotor winding 19W, with benefits including reduced current ripple, improved reference tracking, electromagnetic interference performance improvement, etc. As illustrated in FIG. 7B, double windings 190W of the rotor 19R may be fed by separate converters 60A, 60B in an alternative implementation. Such a configuration offers propulsion with a single branch failure in the rotor 19R. The present teachings may be extended to more than two rotor windings, and therefore the embodiments of FIGS. 7A and 7B are not limiting.

The battery electric system 10 as described thus utilizes the V2X H-bridge 34 of the motor-inverter OBCM 16 shown in FIG. 2 for redundant SEM rotor excitation, in addition to using the primary H-bridge 44 as a primary excitation circuit for the rotor 19R. The method 100 allows for SEM dual-wound rotor field windings to be excited via existing H-bridges that are not used during traction applications, with the method 200 allowing for switching between charging, V2X, and rotor excitation modes as noted above. Loss management of the rotor 19R and associated power electronics may be implemented by the ECU 50, e.g., the ECU 50 may be configured to schedule operation of the different excitation groups or DC power stages (PS1, PS2) when exciting the rotor 19R, to thereby manage losses of the rotor 19R. The availability of multiple secondary DC power stages in the battery electric system 10 allows the rotor 19R to be powered differently depending on the operation of the mobile system 11. Fault-tolerant propulsion is thus ensured using the secondary power stages in conjunction with the multi-wound rotor 19R of the SEM 19. These and other attendant benefits will be readily appreciated by those skilled in the art now having the benefit of the present teachings.

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A battery electric system, comprising:
a battery pack;
a dual-wound separately excited machine (SEM) having an output member, a stator having stator windings connectable to a charging inlet, and a rotor having a first set of rotor windings and a second set of rotor windings;
a transformer;
a motor-inverter onboard charging module (OBCM) connected to the battery pack and to a charging inlet, wherein the charging inlet is selectively connectable to the stator windings to energize the motor-inverter OBCM and charge the battery pack, the motor-inverter OBCM including:
a first DC power stage (PS1) having a plurality of semiconductor switches arranged in a vehicle-to-anything (V2X) H-bridge of the motor-inverter OBCM, the V2X H-bridge being selectively connectable to a power outlet or the first set of rotor windings via a first mode switch (SM1);
a second DC power stage (PS2) connected to the first DC power stage (PS1) via the transformer, and having a plurality of semiconductor switches arranged in a primary H-bridge of the motor-inverter OBCM, the primary H-bridge being selectively connectable the second set of rotor windings via a second mode switch (SM2); and
an electronic control unit (ECU) configured to control an ON/OFF switching state of the first mode switch (SM1) and the second mode switch (SM2) to independently energize the first set of rotor windings and the second set of rotor windings via the second and first DC power stages, respectively.

2. The battery electric system of claim 1, wherein the ECU is configured to independently energize the first set of rotor windings via the first DC power stage in response to a detected fault of the second DC power stage, and vice versa.

3. The battery electric system of claim 1, wherein the SEM is a contact-type SEM.

4. The battery electric system of claim 1, wherein the SEM is a noncontact-type SEM.

5. The battery electric system of claim 4, wherein the noncontact-type SEM includes:
a multi-winding rotary transformer having a stationary primary side and a rotating secondary side; and
a pair of rectifier circuits each connected to the rotating secondary side of the multi-winding rotary transformer.

6. The battery electric system of claim 1, wherein the first set of rotor windings and the second set of rotor windings have an equal number of turns.

7. The battery electric system of claim 1, wherein the first set of rotor windings and the second set of rotor windings have a different number of turns.

8. The battery electric system of claim 1, further comprising:
a sensor operable for sensing a temperature of the rotor, wherein the ECU is configured to switch between the first DC power stage and the second DC power stage based at least in part on the temperature of the rotor to thereby minimize losses in the rotor.

9. The battery electric system of claim 1, wherein the primary H-bridge of the second DC power stage is operable for outputting a split-phase, 120V/240V output to the power outlet.

10. The battery electric system of claim 1, wherein the motor-inverter OBCM includes a power factor correction (PFC) stage operable for receiving a single-phase alternating current (AC) voltage from the charging inlet.

11. The battery electric system of claim 1, wherein the motor-inverter OBCM is operable for receiving a direct current fast-charging (DCFC) voltage from the charging inlet.

12. The battery electric system of claim 1, wherein the ECU is configured to determine a rotor load condition of the rotor, and to independently adjust a corresponding utilization rate of the first DC power stage and the second DC power stage based on the rotor load condition.

13. The battery electric system of claim 12, wherein the ECU is programmed with load designations or cutoffs for the rotor load conditions, including a nominal load, a peak load, and a light load, and the ECU is configured to independently adjust the corresponding utilization rate to:
50% for each of the first DC power stage and the second DC power stage during the nominal load, thus balancing losses between the first DC power stage and the second power stage;
100% for each of the first DC power stage and the second DC power stage during the peak load; and
less than 40% for the first DC power stage or the second DC power stage, during the light load, while placing the other of the first DC power stage or the second DC power stage placed in a standby mode.

14. The battery electric system of claim 1, wherein the ECU is configured to manage losses of the rotor by scheduling operation of the first DC power stage and the second DC power stage when exciting the rotor.

15. A vehicle comprising:
a vehicle body;
a set of road wheels connected to the vehicle body;
a charging inlet connected to the vehicle body;
a power outlet connected to the vehicle body; and
a battery electric system, comprising:
a battery pack;
a dual-wound separately excited machine (SEM) having an output member connected to one or more of the road wheels, a stator having stator windings connectable to a charging inlet, and a rotor having a first set of rotor windings and a second set of rotor windings;
a transformer; a motor-inverter onboard charging module (OBCM) connected to the battery pack and to the charging inlet, wherein the charging inlet is selectively connectable to the stator windings to energize the motor-inverter OBCM and charge the battery pack, the motor-inverter OBCM including:
a first direct current (DC) power stage (PS1) having a plurality of semiconductor switches arranged in a vehicle-to-anything (V2X) H-bridge of the motor-inverter OBCM, the V2X H-bridge being selectively connectable to the power outlet or the first set of rotor windings via a first mode switch (SM1);
a second DC power stage (PS2) connected to the first DC power stage (PS1) via the transformer, and having a plurality of semiconductor switches arranged in a primary H-bridge of the motor-inverter OBCM, the primary H-bridge being selectively connectable to the power outlet or the second set of rotor winding via a second mode switch (SM2); and
an electronic control unit (ECU) configured to control an ON/OFF switching state of the first mode switch (SM1) and the second mode switch (SM2) to independently energize the first set of rotor windings and the second set of rotor windings via the second and first DC power stages, respectively.

16. The vehicle of claim 15, wherein the ECU is configured to independently energize the first set of rotor windings via the first DC power stage in response to a detected fault of the second DC power stage, and vice versa.

17. The vehicle of claim 15, further comprising:
a sensor operable for sensing a temperature of the rotor, wherein the ECU is configured to switch between the first DC power stage and the second DC power stage based at least in part on the temperature of the rotor to thereby minimize losses in the rotor.

18. The vehicle of claim 15, wherein the ECU is configured to determine a rotor load condition of the rotor, and to independently adjust a corresponding utilization rate of the first DC power stage and the second DC power stage based on the rotor load condition.

19. A method for controlling a dual-wound separately excited machine (SEM) in a battery electric circuit of a vehicle, comprising:
determining, via an electronic control unit (ECU) of the vehicle, a mode of operation of the battery electric circuit as one of an initialization mode, a charging mode of a battery pack of the battery electric circuit, and a propulsion mode of the vehicle; and
controlling an ON/OFF switching state of a first mode switch (SM1) and a second mode switch (SM2) of a motor-inverter onboard charging module (OBCM) of the battery electric circuit, via the ECU, to independently energize a first set of rotor windings of the SEM and a second set of rotor windings of the SEM via respective first and second direct current (DC) power stages of the motor-inverter OBCM, the first and second DC power stages each having a corresponding plurality of semiconductor switches arranged in a respective H-bridge, wherein controlling the ON/OFF switching state of the first mode switch (SM1) and the second mode switch (SM2) includes independently energizing the first set of rotor windings via the first DC power stage in response to a detected fault of the second DC power stage, and vice versa.

20. The method of claim 19, further comprising:
determining a rotor load condition of the rotor via the ECU; and
independently adjusting a corresponding utilization rate of the first DC power stage and the second DC power stage via the ECU based on the rotor load condition.
